(19) United States
(12) Patent Application Publication
(10) Pub. No.: US 2004/0045458 A1
(43) Pub. Date: Mar. 11, 2004

(54) Method and apparatus for releasing materials from stencils

(76) Inventors: Gerald Pham-Van-Diep, Hopkinton, MA (US); Frank Andres, Saunderstown, RI (US)

Correspondence Address: Thomas M. Sullivan, Esq., Mintz, Levin, Cohn, Ferris,, Glovsky and Popeo, P.C., One Financial Center, Boston, MA, 02111, US

(21) Appl. No.: 10/236,108

(22) Filed: Sep. 6, 2002

(51) Int. Cl. B41L 13/18

(52) U.S. Cl. 101/123

(57) ABSTRACT

An apparatus and method for depositing material on a surface of an electronic substrate includes a frame, a substrate support coupled to the frame to support the electronic substrate, a stencil coupled to the frame having at least one aperture to receive a material to be deposited through the aperture onto the surface of the electronic substrate, a controller that controls dispensing of material on the substrates, and a vibration system, coupled to one of the stencil, the frame and the substrate support, and coupled to the controller, that introduces a vibration to the stencil, wherein the vibration has a frequency controlled by the controller based on characteristics of at least one of the material, the stencil and the electronic substrate. Release of material from the apertures is accomplished while the vibration is applied to the stencil.

### FIELD OF THE INVENTION

The invention relates to apparatus and methods for screen printing, and more specifically to apparatus and methods for the screen printing of electronic substrates such as circuit board assemblies.

### BACKGROUND OF THE INVENTION

The manufacturing of circuit boards involves many processes, one of which is the screen printing of solder paste and adhesives onto printed circuit boards so that electronic components can thereafter be deposited onto the boards. To apply solder paste and surface mount components to a surface of a circuit board, a stencil with an aperture or a plurality of apertures defines a pattern that corresponds to the pattern of pads already disposed on the circuit board. The stencil is then placed substantially parallel to the surface of the board to be printed and the apertures are aligned with the desired pattern on the substrate surface. The solder paste or other material to be deposited is then placed on top of the stencil for deposition into the aperture or apertures and onto the board. Once the apertures are filled with material, excess material may be removed from the top of the stencil, using for example a squeegee, so that substantially all of the material that remains is in the aperture or apertures. The stencil is then separated from the board and the surface tension between the board and the material causes most of the material to stay on the board.

The pads used on circuit boards are continuing to become smaller and smaller, and accordingly, the size of apertures on stencils is also becoming smaller. For small apertures, the surface tension between the material and the board is not always sufficient to cause most of the material in the aperture to transfer from the stencil to the board. Known means of improving the release of materials from stencils are described in Hertz, U.S. Pat. No. 6,138,562; and Ray, U.S. Pat. No. 5,407,488. However, it is desirable to provide a screen printer with improved material release than those known in the prior art.

### SUMMARY OF THE INVENTION

One aspect of the present invention is directed to an apparatus for performing operations on a surface of an electronic substrate. The apparatus includes a frame, a substrate support, coupled to the frame, to support the electronic substrate, a stencil coupled to the frame having at least one aperture to receive a material to be deposited through the aperture onto the surface of the electronic substrate, a controller that controls dispensing of materials on substrates, and a vibration system, coupled to one of the stencil, the frame and the substrate support and coupled to the controller, that introduces a vibration to the stencil. The vibration has a frequency controlled by the controller based on characteristics of at least one of the material, the stencil and the electronic substrate.

The vibration system can include an actuator coupled to the stencil to cause vibration of the stencil. The vibration system can include an actuator coupled to the substrate support to cause vibration of the substrate. The vibration system can include an actuator coupled to the frame to cause vibration of the frame. At least one aperture can have an aperture size, and the controller can control the frequency based on the aperture size. The controller can control the frequency based on the material deposited through the aperture onto the electronic substrate. The controller can control the frequency over a range from 3000 Hz to 30,000 Hz. The electronic substrate can have a marking, whereby the controller controls the frequency based on detection of the marking on the electronic substrate. The stencil can have a marking, whereby the controller controls the frequency based on detection of the marking on the stencil.

Another aspect of the present invention is directed to a method of dispensing material on a surface of an electronic substrate. The method includes loading an electronic substrate into a printing apparatus, supporting the substrate with a substrate support during dispensing, aligning a stencil above a surface of the electronic substrate, the stencil having at least one aperture having an aperture size through which material is deposited onto the surface of the electronic substrate, determining a vibration frequency based on the characteristics of at least one of the material, the stencil and the electronic substrate, depositing the material onto the surface of the electronic substrate, and vibrating one of the stencil, the frame and the substrate support at the vibration frequency.

The method can further include coupling an actuator to the stencil to vibrate the stencil. The method can further include coupling an actuator to the substrate support to vibrate the substrate support. The method can further include coupling an actuator to the frame to vibrate the frame. The method can still further include controlling the vibration frequency based on the aperture size, characteristics of the material, or characteristics of the substrate. The method can further include loading a second electronic substrate into the printing apparatus and changing the vibration frequency according to characteristics of the second electronic substrate. The method can include adjusting the frequency of the vibration over a range from 3000 Hz to 30,000 Hz., and vibrating the stencil while separating the stencil from the electronic substrate following deposition of material on the electronic substrate.

Yet another aspect of the invention is directed to an apparatus for dispensing material on at least one surface of an electronic substrate. The apparatus includes a frame, a substrate support, coupled to the frame, to support the electronic substrate, a stencil coupled to the frame having at least one aperture to receive a material to be deposited through the aperture onto the surface of the electronic substrate, a controller that controls dispensing of materials on substrates, and means for vibrating the stencil with an adjustable frequency based on the characteristics of at least one of the material, the stencil and the electronic substrate.

### BRIEF DESCRIPTION OF THE FIGURES

For a better understanding of the present invention, reference is made to the drawings which are incorporated herein by reference and in which:

FIG. 1 is a perspective view of a printing apparatus in accordance with one embodiment of the invention;

FIG. 2 is a schematic diagram of a solder paste release system in one embodiment of the present invention;

FIG. 3 is a schematic diagram of a solder paste release system in another embodiment of the present invention;

FIG. 4 is a schematic diagram of a solder paste release system in another embodiment of the present invention;

FIG. 5 is a schematic diagram of a solder paste release system in another embodiment of the present invention; and

FIG. 6 is a flow chart diagramming the solder paste release method in accordance with one embodiment of the invention.

### DETAILED DESCRIPTION OF PREFERRED EMBODIMENTS

Embodiments of the present invention are described below with reference to screen printers or stencil printers that print solder paste onto circuit boards. As understood by those skilled in the art, embodiments of the present invention can be used with electronic substrates other than circuit boards and with machines other than screen printers.

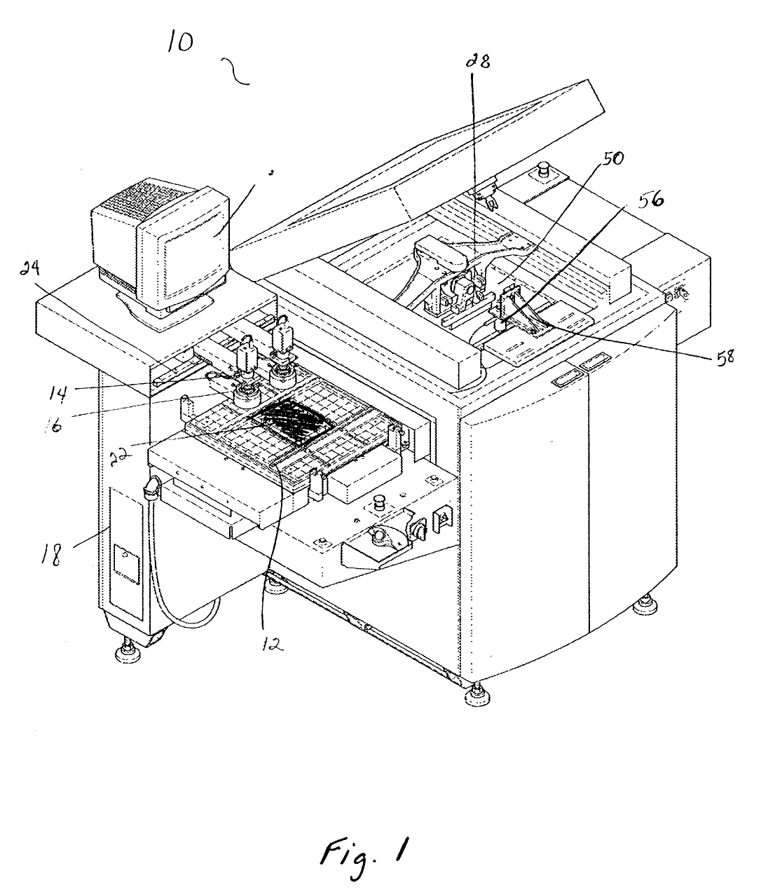

Referring to FIG. 1, a printer 10 in accordance with one embodiment of the invention that applies solder paste or other materials to substrates, such as circuit boards, is shown. The printer is an improvement over the screen printer described in U.S. Pat. No. 5,794,329 and U.S. Pat. No. 6,324,973, each of which is hereby incorporated by reference.

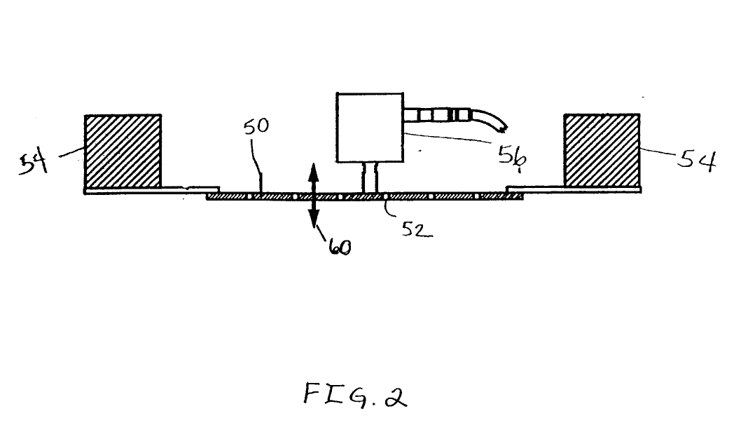

As shown in FIG. 1, the printer 10 includes a tractor feed mechanism 12, cameras 14 carried on a carriage 16, a controller 18 and a monitor 19, a squeegee/solder dispenser 28, a stencil 50, and an actuator 56. The cameras 14 carried on the carriage 16 are moveable along tracks 24 so that they may move in both a linear X-axis of motion and a linear Y-axis of motion. The solder stencil 50 is attached to the printer frame above the circuit board 22. The circuit board enters the printer on the tractor feed mechanism 12. The squeegee/solder dispenser 28 is attached to the printer 10 in a position above the level of the solder stencil 50. The solder stencil 50 has apertures 52 (shown in FIG. 2) through which solder is deposited on the surface of a circuit board.

Boards 22 fed into the printer 10 typically have a pattern of pads or other, usually conductive surface areas onto which solder paste will be deposited. When directed by the controller 18 of the printer, the tractor feed mechanism 12 supplies boards 22 to a location where the camera 14 records an image of the circuit board 22. The image is sent to the controller, which signals to shuttle the board 22 to a second location over a board support 20 and under the stencil 50. Once arriving at a position under the stencil 50, the circuit board 22 is in place for a manufacturing operation. To successfully deposit solder paste on the board 22, the board 22 and the stencil 50 are aligned, via the controller. When the solder stencil 50 and the circuit board 22 are aligned correctly, the stencil is lowered toward the board 22 for application of the solder paste through the apertures 52, or the board can be raised toward the stencil by a support mechanism 20.

The pattern of the apertures 52 corresponds to the pattern of conductive surfaces or pads already on the board 10. The squeegee/solder dispenser 28, positioned above the circuit board 22, can vary the amount of solder paste delivered on the stencil 50 and applied by the squeegee. The squeegee 28 wipes across the stencil, thereby pushing solder paste into the stencil apertures, and from here, the solder paste will be released onto the board 22. After solder paste has been deposited on the circuit board 22 in the proper pattern, the support mechanism 20 moves downward away from the position of the board, or the stencil moves upward away from the board, under control of the controller. The controller then controls movement of the board 22 to the next location using the tractor mechanism, where electrical components will be placed on the board 22 in position where the solder paste was printed.

As discussed, during the deposition of solder paste onto the surface of the boards 22, the stencil 50 is aligned so that apertures 52 correspond in shape and size to areas on the circuit board onto which solder paste is to be deposited. When aligned, the solder paste dispenser 28 releases solder paste or other adhesive onto the surface of the stencil whereby it fills the apertures 52. The squeegee 28 aids in the process of filling the apertures 52 by wiping over the top surface of the stencil 50 to push the solder paste through each of the apertures 52 and onto the desired locations on the surface of the circuit board. Solder paste is released onto the surface of the board 22 when the stencil 50 is moved away from the board, or when the board 22 is moved down and away from the stencil. During this phase, it is desirable to apply a substantially consistent amount of solder paste over each surface of the board where electronic substrates will be placed.

Referring to FIG. 2, because the apertures are generally small in size, in prior art printers, solder paste often gets caught in the apertures 52 as the solder paste is deposited onto the circuit board 22. In embodiments of the present invention, to separate the solder paste from the edges of the apertures 52, an actuator 56 is used to introduce a vibration to the stencil that aids in the removal of solder paste from the stencil 50. The actuator may be a magnetostrictive device, manufactured by Etrema of Ames, Iowa, or it may be any device that introduces vibrations in a mechanical system to enhance the release of solder paste from the aperture of a stencil, such as piezoelectrics and voice coils.

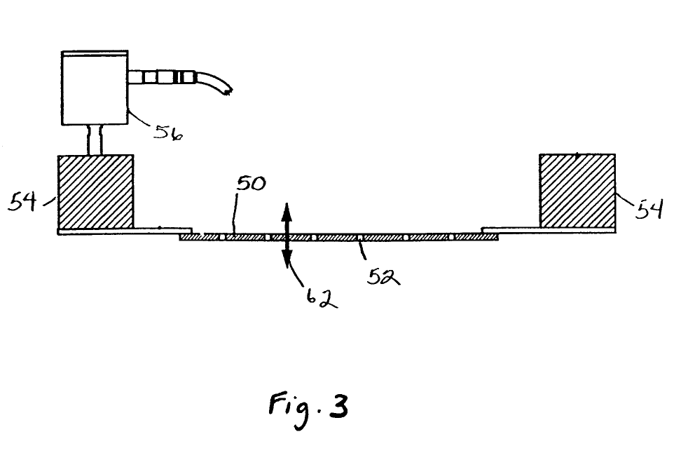

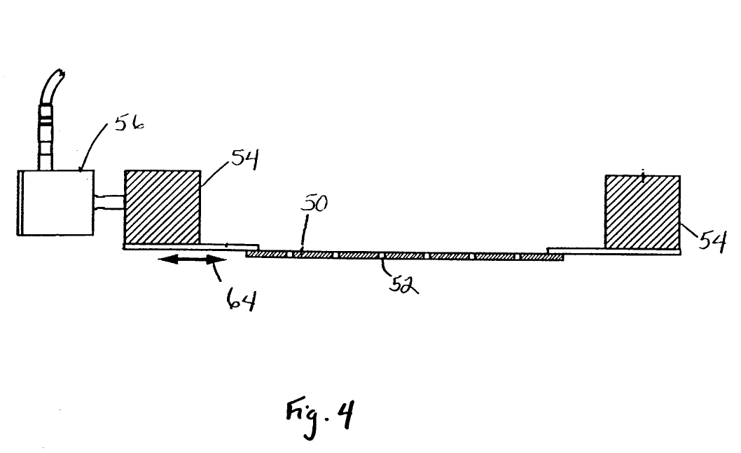

The actuator 56 is placed on the stencil 50 so that the stencil vibrates as the stencil and circuit board are separated, causing the solder paste to loosen from the sides of the apertures 52 and thereby improving the release of the solder paste onto the circuit boards. In other embodiments, as shown in FIGS. 3 and 4, the actuator 56 may be used to vibrate the frame of the stencil 54, which thereafter creates vibration in the stencil itself. The actuator 56 can be attached to the stencil frame to cause vibration in the horizontal direction, as shown in FIG. 4, or it can be attached to cause vibration in the vertical direction, as shown in FIG. 3.

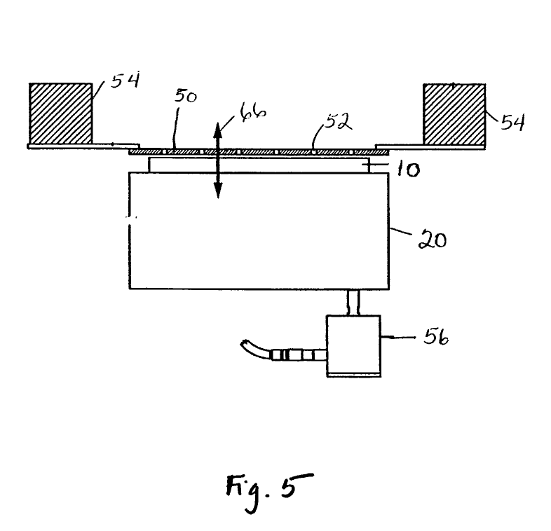

An additional embodiment, shown in FIG. 5, depicts the actuator 56 in contact with the substrate support system 20, which is in contact with the circuit board 22. When the circuit board 22 is vibrated, the stencil is vibrated, causing solder paste in contact with the stencil to release to the surface of the substrate. By vibrating the stencil 50 or the substrate 22, solder paste will be transferred from the stencil to the circuit board to provide substantially consistent volumes of paste during printing operations. The vibration originating with the actuator 56 can be applied during filling of the apertures 52 with solder paste and during release of the solder paste onto the circuit board 22.

Typically, the size and shape of the apertures, the number of apertures, the particular solder paste used, and the thickness of the apertures, for example, are characteristics that affect the release of solder paste from the apertures for deposit onto the circuit boards. In embodiments of the present invention, the frequency and/or amplitude of vibration applied to the stencil or board is optimized based on the characteristics of the stencil, board and material. In one embodiment, the controller controls the frequency and/or amplitude of the vibration to be selected in accordance with the size of the apertures and the type of solder paste. The frequency can be selected by either the user or by the system itself. For example, the system may be programmed to respond to particular dimensions or materials so that it can respond with a proper vibration frequency, or a user may input a desired frequency of vibration. Additionally, the frequency may be adjusted by using the controller, where the controller is programmed to detect distinct markings that appear on the stencil or on the circuit board and adjust the frequency according to the markings. In one embodiment, the frequency is controllable between 3000 Hz and 30,000 Hz. Using frequencies in this range has been found to cause a stencil displacement of 1-50 microns when the vibration is applied perpendicular to the plane of the stencil 50.

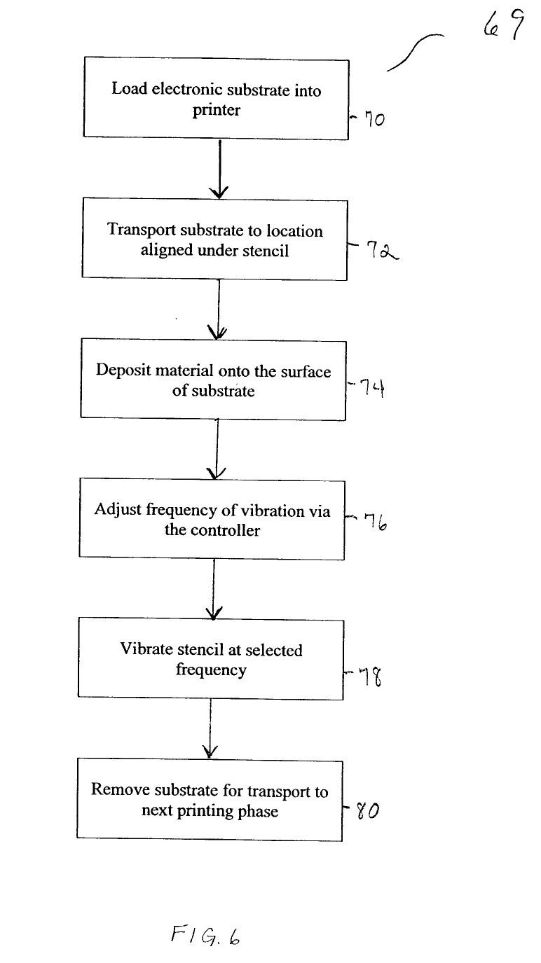

A flow chart depicting a method 69 by which the vibration system operates is found in FIG. 6. The first stage 70 is to load the circuit board 22 into the printer 10, where it is then transported to a next location and aligned under the stencil 50 in step 72. According to the next stage 74, solder paste is deposited onto the surface of the circuit board 22 in a position determined by the pads already on the surface of the board. After deposition of the solder paste, the frequency or amplitude of vibration of the stencil 50 is adjusted in stage 76, either by the controller 18 or by the user, so that the stencil 50 can be vibrated to achieve the release of the solder paste onto the circuit board 22. The stencil 50 is then vibrated at the selected frequency in the next stage 78, and thereafter the circuit board 22 is transported to the next printing phase with the solder paste on its surface.

In the embodiments of the present invention described above, the actuator contacts the stencil, stencil frame or the substrate support system. As understood by those skilled in the art, other configurations may include an actuator that is not in contact with the stencil, stencil frame, or substrate support system, but that creates a vibration that vibrates the stencil or substrate at the desired frequencies without direct contact.

In the embodiments of the present invention described above, the stencil deposits solder paste onto the surface of a circuit board. As understood by those skilled in the art, other configurations may include materials other than solder paste deposited onto other electronic substrates or some other substrate.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. An apparatus for performing operations on a surface of an electronic substrate, the apparatus comprising:
a frame;
a substrate support, coupled to the frame, to support the electronic substrate;
a stencil coupled to the frame having at least one aperture to receive a material to be deposited through the aperture onto the surface of the electronic substrate;
a controller that controls dispensing of materials on substrates; and
a vibration system, coupled to one of the stencil, the frame and the substrate support and coupled to the controller, that introduces a vibration to the stencil;
wherein the vibration has a frequency controlled by the controller based on characteristics of at least one of the material, the stencil and the electronic substrate.

2. The apparatus of claim 1, wherein the vibration system includes an actuator coupled to the stencil to cause vibration of the stencil.

3. The apparatus of claim 2, wherein the vibration system includes an actuator coupled to the substrate support to cause vibration of the substrate.

4. The apparatus of claim 3, wherein the vibration system includes an actuator coupled to the frame to cause vibration of the frame.

5. The apparatus of claim 4, wherein the at least one aperture has an aperture size, and wherein the controller controls the frequency based on the aperture size.

6. The apparatus of claim 5, wherein the controller controls the frequency based on the material deposited through the aperture onto the electronic substrate.

7. The apparatus of claim 6, wherein the controller controls the frequency over a range from 3000 Hz to 30,000 Hz.

8. The apparatus of claim 1, wherein the electronic substrate has a marking, whereby the controller controls the frequency based on detection of the marking on the electronic substrate.

9. The apparatus of claim 1, wherein the stencil has a marking, whereby the controller controls the frequency based on detection of the marking on the stencil.

10. The apparatus of claim 1, wherein the vibration system includes an actuator coupled to the substrate support to cause vibration of the substrate.

11. The apparatus of claim 10, wherein the at least one aperture has an aperture size, and wherein the controller controls the frequency based on the aperture size.

12. The apparatus of claim 11, wherein the controller controls the frequency based on the material deposited through the aperture onto the electronic substrate.

13. The apparatus of claim 1, wherein the vibration system includes an actuator coupled to the frame to cause vibration of the frame.

14. The apparatus of claim 13, wherein the at least one aperture has an aperture size, and wherein the controller controls the frequency based on the aperture size.

15. The apparatus of claim 14, wherein the controller controls the frequency based on the material deposited through the aperture onto the electronic substrate.

16. A method of dispensing material on a surface of an electronic substrate, the method comprising:
loading an electronic substrate into a printing apparatus;
supporting the substrate with a substrate support during dispensing;
aligning a stencil above a surface of the electronic substrate, the stencil having at least one aperture having an aperture size through which material is deposited onto the surface of the electronic substrate;
determining a vibration frequency based on the characteristics of at least one of the material, the stencil and the electronic substrate;
depositing the material onto the surface of the electronic substrate;
vibrating one of the stencil, the frame and the substrate support at the vibration frequency.

17. The method of claim 16 further comprising coupling an actuator to the stencil to vibrate the stencil.

18. The method of claim 16 further comprising coupling an actuator to the substrate support to vibrate the substrate support.

19. The method of claim 16 further comprising coupling an actuator to the frame to vibrate the frame.

20. The method of claim 16 further comprising controlling the vibration frequency based on the aperture size.

21. The method of claim 20 further comprising controlling the vibration frequency based on the material.

22. The method of claim 16 further comprising loading a second electronic substrate into the printing apparatus and changing the vibration frequency according to characteristics of the second electronic substrate.

23. The method of claim 22 further comprising adjusting the frequency of the vibration over a range from 3000 Hz to 30,000 Hz.

24. The method of claim 16 further comprising vibrating the stencil while separating the stencil from the electronic substrate following deposition of material on the electronic substrate.

25. An apparatus for dispensing material on at least one surface of an electronic substrate, the apparatus comprising:
a frame;
a substrate support, coupled to the frame, to support the electronic substrate;
a stencil coupled to the frame having at least one aperture to receive a material to be deposited through the aperture onto the surface of the electronic substrate;
a controller that controls dispensing of materials on substrates; and
means for vibrating the stencil with an adjustable frequency based on the characteristics of at least one of the material, the stencil and the electronic substrate.

26. The apparatus of claim 25, wherein the vibration system includes an actuator coupled to the stencil to cause vibration of the stencil.

27. The apparatus of claim 26, wherein the vibration system includes an actuator coupled to the substrate support to cause vibration of the substrate support.

28. The apparatus of claim 27, wherein the vibration system includes an actuator coupled to the frame to cause vibration of the frame.

29. The apparatus of claim 28 wherein the frequency ranges from 3000 Hz to 30,000 Hz.

30. The apparatus of claim 29, wherein the aperture has an aperture size, and wherein the controller controls the frequency based on the aperture size.

31. The apparatus of claim 30, wherein the controller controls the frequency based on the material.
